(19) United States
(12) Patent Application Publication
(10) Pub. No.: US 2024/0024835 A1
(43) Pub. Date: Jan. 25, 2024

(54) BURNER ARRANGEMENT FOR SYNTHESIS GAS PRODUCTION

(71) Applicant: L'Air Liquide, Société Anonyme pour I'Etude et I'Exploitation des Procédés Georges Claude, Paris (FR)

(72) Inventors: Dieter ULBER, Steinbach Ts. (DE); Peter WEIGAND, Bad Vilbel (DE); Holger SCHLICHTING, Hofheim (DE); Stefan WALTER, Griesheim (DE)

(21) Appl. No.: 18/224,363

(22) Filed: Jul. 20, 2023

(30) Foreign Application Priority Data
Jul. 21, 2022 (EP) 22020352.5

(51) Int. Cl. B01J 8/18; B01J 19/24; B01J 19/00; B01J 19/02; B01J 8/00; C01B 3/36

(52) U.S. Cl. CPC B01J 8/1836; B01J 19/24; B01J 19/0013; B01J 19/02; B01J 8/1827; B01J 8/0015; C01B 3/363; B01J 2219/00157; B01J 2208/00504; C01B 2203/0255; C01B 2203/0261; B01J 2219/024

(57) ABSTRACT

Provided is a burner arrangement for producing synthesis gas by non-catalytic or catalytic partial oxidation of fluid or fluidized carbon-containing fuels in the presence of an oxidant and a moderator, including following assemblies: (a) a feeding means for separately feeding three fluid reaction media streams or two fluid and one fluidized reaction media stream into a burner, (b) at least one burner, (c) outer wall of the at least one burner is fluid-tightly connected to a burner mounting plate, (d) a reaction chamber, (e) the at least one burner is insertable into the reaction chamber, and (f) outer wall of the at least one burner and the side of the at least one burner mounting plate facing away from the interior of the reaction chamber are designed to allow cooling by indirect heat exchange with a cooling fluid.

### CROSS REFERENCE TO RELATED APPLICATIONS

This application claims the benefit of priority under 35 U.S.C. § 119 (a) and (b) to European Patent Application No. 22020352.5, filed Jul. 21, 2022, the entire contents of which are incorporated herein by reference.

### TECHNICAL FIELD

The present disclosure relates generally to a burner for synthesis gas production by partial oxidation of carbon-containing fuels; more specifically, the present disclosure relates to a burner arrangement comprising of one or more media cooled co-annular feed channels for carbon-containing fuels, oxidant, and moderator, which are embedded in a refractory lining of the PDX (partial oxidation) reactor characterized by water cooling that is distant to the high-temperature synthesis gas atmosphere inside the PDX reactor.

### BACKGROUND

Typically, a synthesis gas comprising components like hydrogen and carbon monoxide, is produced in a reactor comprising of a burner, and a reaction chamber in which a mixture of reactants, such as natural gas and oxygen, is transformed into the synthesis gas. In general, burners are installed at the head of the reactor such that their flame is vertically guided into the reactor from top to bottom so that the lower end of the burner is exposed to high temperatures and the corrosive atmosphere of a combustion chamber. EP1200338B1 describes a burner with integrated water-cooling of an injection device front plate. EP0127273B1 and EP0315225B1 describe injection devices with co-annular injection pipes. EP1016705B1 describes a co-annular injection device with internal steam atomization. EP2603451 describes an injection device with a protective layer on the front plate. EP0640679A1 describes a synthesis gas burner that uses a porous ceramic or porous metal plate or cup to shield and cool the downstream end of the burner from the hot hostile environment within a gas generator. U.S. Pat. No. 5,273,212A describes a synthesis gas burner where the downstream face of the cooling chamber is clad with a layer composed of individual, adjacently arranged, ceramic platelets. There is also prior art available describing a co-annular injection device that is surrounded by a cooling flange. The purpose of the cooling flange however is to avoid stress and leakage of synthesis gas via the flange connection.

The prior art describes an injection device with several co-annular injection lances, which are embedded in a water-cooled metal front plate. However, the water-cooled metal front plate may be under severe mechanical stress which is caused by the temperature difference between the high-temperature synthesis gas atmosphere in a PDX (partial oxidation) reactor with heat flux from radiation and convection in a range of 0.5 to 3.0 megawatt (MW)/square meter (m²) and between a cooling water flow rate with heat transfer coefficients of approx. 1-50 kilowatt (kW)/square meter Kelvin (m²K). This mechanical stress from the high temperature gradient, the high-temperature synthesis gas atmosphere close to the metal front plate, and the corrosive components in the synthesis gas may result in the operating lifetimes of the injection device being less than the turn-around period of the PDX reactor.

On the other hand, other prior art described above with media cooled co-annular injection lances have short operating lifetimes because of the high temperature of the metal lances during shut-down of the reactor because the cooling flow of the feed and oxidizer has to be interrupted. Other media for cooling during shut-down of the reactor, such as high-pressure nitrogen or steam, which are injected into the feed, oxidizer, and/or steam annulus, are not always available.

The co-annular injection device that is surrounded by the cooling flange does not prevent high temperature and related damage/change of the material properties of the co-annular lances themselves, as only the flange connection of the device is cooled. Synthesis gas break-through through either the oxidizer or feed injection lances cannot be safely prevented.

Therefore, there is a need to address the aforementioned technical drawbacks in existing technologies in burners in order to improve the operational efficiency for synthesis gas production.

### SUMMARY

The present disclosure seeks to provide a burner arrangement for feeding hydrocarbon feedstock into a reactor for partial oxidation (PDX) of gaseous feed (Gas-PDX) or liquid feed such as preheated oil residue (Residue-PDX/Gasification), for autothermal reforming or for gasification of coal or coke (Coal/Coke Gasification). The present disclosure aims to provide a solution that overcomes, at least partially, the problems encountered in the prior art and provide an improved burner arrangement comprising of one or more media-cooled co-annular feed channels for carbon-containing fuels, oxidant, and moderator, which are embedded in a refractory lining of a PDX reactor characterized by water cooling that is distant to the high temperature synthesis gas atmosphere inside the reactor. The object of the present disclosure is achieved by the solutions provided in the enclosed independent claims. Advantageous implementations of the present disclosure are further defined in the dependent claims.

According to a first aspect, the present disclosure provides a burner arrangement for producing a hydrogen and carbon oxides containing synthesis gas by non-catalytic or catalytic partial oxidation of fluid or fluidized carbon-containing fuels in the presence of an oxygen-containing oxidant and a moderator containing steam and/or carbon dioxide, comprising following parts or assemblies:
(a) means for separately feeding three fluid reaction media streams or two fluid and one fluidized reaction media streams into a burner, wherein the three reaction media streams are selected from the group comprising: a fluid or fluidized carbon-containing fuel stream, an oxygen-containing oxidant stream and a moderator stream,
(b) at least one burner, comprising:
   (b1) a first feed channel having a circular cross section, allowing feeding of the first reaction medium stream,
   (b2) a second feed channel which coaxially and concentrically surrounds the first feed channel, forming an annular gap between the outer wall of the first feed channel and the inner wall of the second feed channel, allowing feeding of the second reaction medium stream,
   (b3) optionally a third feed channel which coaxially and concentrically surrounds the second feed channel, forming an annular gap between the outer wall of the second feed channel and the inner wall of the third feed channel, allowing feeding of the third reaction medium stream,
   (b4) wherein the outer wall of the second feed channel or optionally the outer wall of the third feed channel forms the outer wall of the at least one burner,
   (b5) wherein the outer walls of all feed channels end in a first common plane that runs perpendicularly to the longitudinal axis of the burner and forms a burner mouth,
(c) wherein the outer wall of the at least one burner is mounted on and is fluid-tightly connected to a burner mounting plate in such a way that a part A of the length of the feed channels is passed through the burner mounting plate and a part B of the length of the feed channels is not passed through the burner mounting plate,
(d) a reaction chamber, wherein the reaction chamber comprises:
   a pressure bearing wall with an outer wall surface and an inner wall surface,
   a refractory lining attached to the inner wall surface of the pressure bearing wall,
   an interior, being defined as the free space inside the reaction chamber, delimited by an inner surface of the refractory lining, and
   an opening for insertion of the at least one burner mounted on the burner mounting plate into the reaction chamber,
(e) wherein the at least one burner mounted on the burner mounting plate is insertable into the reaction chamber via the opening in such a way that the part A of the length of the feed channels is located at least partially inside of the interior and/or inside of the refractory lining, and the part B of the length of the feed channels is located outside of the interior of the reaction chamber, and the burner mounting plate is detachably connectable in a fluid-tight manner, preferably using a flange connection, to the outer wall surface,
(f) wherein both the portion of the outer wall of the at least one burner corresponding to part B of the length of the feed channels and the side of the at least one burner mounting plate facing away from the interior of the reaction chamber are designed to allow cooling by indirect heat exchange with a cooling fluid.

The burner arrangement according to the present disclosure is of advantage in that the burner arrangement minimizes the metal in contact with the high-temperature synthesis gas atmosphere, for example by co-annular feed channels with small wall thicknesses toward the high-temperature synthesis gas atmosphere. The co-annular feed channels are shielded from the high-temperature synthesis gas atmosphere by the refractory lining of the reactor or a dedicated refractory of the burner inserted into the reactor. Further, the burner arrangement enables cooling of the metal exposed to the high-temperature synthesis gas atmosphere by the process media/fluids such as carbon-containing fuels, oxidant, and moderator in such a manner that the heat transfer is best on the side of the lower temperature fluid or on the side of the fluid with the best heat transfer coefficient for cooling. For operation cases, where the media cooling fails, water-cooling of the feed channels starts which is distant to the high-temperature synthesis gas atmosphere at a level of the reactor metal shell. The water-cooling surrounds all injected media and prevents the break-through of high-temperature synthesis gas. This segregated cooling far from the high-temperature synthesis gas atmosphere ensures sufficient cooling of the burner arrangement during all operational cases. In addition, the high mechanical stress of the parts in contact with the high-temperature synthesis gas atmosphere is avoided. The high-temperature synthesis gas atmosphere cannot burn backward via the oxygen or feed channels so the burner arrangement is inherently safe. Accordingly, the operational life of the burner is improved.

According to a second aspect, the present disclosure provides a use of a burner arrangement for producing a hydrogen and carbon oxides containing synthesis gas by oxidation of fluid or fluidized carbon-containing fuels in the presence of an oxygen-containing oxidant and a moderator containing steam and/or carbon dioxide by catalytic partial oxidation (CPDX), non-catalytic partial oxidation (PDX) or autothermal reforming (ATR).

Use of the burner arrangement in synthesis gas production is of advantage in that the burner arrangement minimizes the metal in contact with the high-temperature synthesis gas atmosphere and also avoids high mechanical stress of the parts in contact with the high-temperature synthesis gas atmosphere. The burner arrangement ensures sufficient cooling of the feed channels and the burner mounting plate during all operational cases.

Embodiments of the present disclosure eliminate the aforementioned drawbacks in existing known approaches by providing a burner arrangement comprising of one or more media cooled co-annular feed channels for carbon-containing fuels, oxidant and moderator. The advantage of the embodiments according to the present disclosure is that the embodiments enable segregated cooling far from the high-temperature gas atmosphere that always makes sure during all operational cases that the burner arrangement is sufficiently cooled and at the same time high mechanical stress of the parts in contact with the high-temperature synthesis gas atmosphere is avoided.

Additional aspects, advantages, features, and objects of the present disclosure are made apparent from the drawings and the detailed description of the illustrative embodiments construed in conjunction with the appended claims that follow. It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. To illustrate the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, the same elements have been indicated by identical numbers. Embodiments of the present disclosure will now be described, by way of example only, with reference to the following diagrams wherein:

FIG. 1A is a schematic illustration of a burner arrangement for producing a hydrogen and carbon oxides containing synthesis gas by non-catalytic or catalytic partial oxidation of fluid or fluidized carbon-containing fuels in the presence of an oxygen-containing oxidant and a moderator containing steam and/or carbon dioxide according to an embodiment of the present disclosure;

FIG. 1B is a schematic illustration of the at least one burner of FIG. 1A according to an embodiment of the present disclosure; and

FIG. 2 is a schematic illustration of a cooling fluid channel of the burner arrangement of FIG. 1A according to an embodiment of the present disclosure.

### DETAILED DESCRIPTION OF THE PREFERRED EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

As used herein, several terms are defined below:

Fluid or fluidized carbon-containing fuels are to be understood as meaning any gases, liquids, slurries, aerosols, pneumatically conveyed solid particles that contain carbon in elementary or chemically bound form, and that continuously flow under an applied shear stress, external force, or pressure difference. A non-exhaustive list of examples comprises hydrocarbonaceous gases like natural gas, hydrocarbonaceous liquids like naphtha, petroleum fractions, liquid refinery residues, solid carbonaceous particles like coal or coke powders or dusts.

An oxygen-containing oxidant is to be understood as any fluid containing oxygen, like pure oxygen at any purity level, air, or any other fluid that is capable of supplying oxygen to a carbon-containing reactant.

A means is to be understood as meaning something that enables or is helpful in the achievement of a goal. In particular, means for performing a particular process step are to be understood as meaning any physical articles that would be considered by a person skilled in the art in order to be able to perform this process step. For example, a person skilled in the art will consider means of introducing or discharging a material stream to include any transporting and conveying apparatuses, i.e., for example pipelines, pumps, compressors, valves, which seem necessary or sensible to said skilled person for performance of this process step on the basis of his knowledge of the art.

For the purposes of this description, steam is to be understood as being synonymous with water vapor unless the opposite is indicated in an individual case. By contrast, the term “water” refers to water in the liquid state of matter unless otherwise stated in an individual case.

Pressures, if any, are reported in absolute pressure units, bara for short, or in gauge pressure units, barg for short, unless otherwise stated in the particular individual context.

A fluid connection between two regions of the apparatus or plant according to the invention is to be understood as meaning any type of connection whatsoever which makes it possible for a fluid, for example, a gas stream, to flow from one to the other of the two regions, neglecting any interposed regions or components. In particular, a direct fluid connection is to be understood as meaning any type of connection whatsoever which makes it possible for a fluid, for example, a gas stream, to flow directly from one to the other of the two regions, wherein no further regions or components are interposed with the exception of purely transportational operations and the means required therefor, for example pipelines, valves, pumps, compressors, reservoirs. One example would be a pipeline leading directly from one to the other of the two regions.

Optional or optionally means that the subsequently described event or circumstances may or may not occur. The description includes instances where the event or circumstance occurs and instances where it does not occur.

According to a first aspect, the present disclosure provides a burner arrangement for producing a hydrogen and carbon oxides containing synthesis gas by non-catalytic or catalytic partial oxidation of fluid or fluidized carbon-containing fuels in the presence of an oxygen-containing oxidant and a moderator containing steam and/or carbon dioxide, comprising following parts or assemblies: (a) means for separately feeding three fluid reaction media streams or two fluid and one fluidized reaction media streams into a burner, wherein the three reaction media streams are selected from the group comprising: a fluid or fluidized carbon-containing fuel stream, an oxygen-containing oxidant stream and a moderator stream, (b) at least one burner, comprising: (b1) a first feed channel having a circular cross section, allowing feeding of the first reaction medium stream, (b2) a second feed channel which coaxially and concentrically surrounds the first feed channel, forming an annular gap between the outer wall of the first feed channel and the inner wall of the second feed channel, allowing feeding of the second reaction medium stream, (b3) optionally a third feed channel which coaxially and concentrically surrounds the second feed channel, forming an annular gap between the outer wall of the second feed channel and the inner wall of the third feed channel, allowing feeding of the third reaction medium stream, (b4) wherein the outer wall of the second feed channel or optionally the outer wall of the third feed channel forms the outer wall of the at least one burner, (b5) wherein the outer walls of all feed channels end in a first common plane which runs perpendicularly to the longitudinal axis of the burner and forms a burner mouth, (c) wherein the outer wall of the at least one burner is mounted on and is fluid-tightly connected to a burner mounting plate in such a way that a part A of the length of the feed channels is passed through the burner mounting plate and a part B of the length of the feed channels is not passed through the burner mounting plate, (d) a reaction chamber, wherein the reaction chamber comprises: a pressure bearing wall with an outer wall surface and an inner wall surface, a refractory lining attached to the inner wall surface of the pressure bearing wall, an interior, being defined as the free space inside the reaction chamber, delimited by an inner surface of the refractory lining, and an opening for insertion of the at least one burner mounted on the burner mounting plate into the reaction chamber, (e) wherein the at least one burner mounted on the burner mounting plate is insertable into the reaction chamber via the opening in such a way that the part A of the length of the feed channels is located at least partially inside of the interior and/or inside of the refractory lining, and the part B of the length of the feed channels is located outside of the interior of the reaction chamber, and the burner mounting plate is detachably connectable in a fluid-tight manner, preferably using a flange connection, to the outer wall surface, (f) wherein both the portion of the outer wall of the at least one burner corresponding to part B of the length of the feed channels and the side of the at least one burner mounting plate facing away from the interior of the reaction chamber are designed to allow cooling by indirect heat exchange with a cooling fluid.

The burner arrangement according to the present disclosure is of advantage in that the burner arrangement minimizes the metal in contact with the high-temperature synthesis gas atmosphere, for example by co-annular feed channels with small wall thicknesses toward the high-temperature synthesis gas atmosphere. The co-annular feed channels are shielded from the high-temperature synthesis gas atmosphere by the refractory lining of the reactor or a dedicated refractory of the burner inserted into the reactor. Further, the burner arrangement enables cooling of the metal exposed to the high-temperature synthesis gas atmosphere by the process media/fluids such as carbon-containing fuels, oxidant, and moderator in such a manner that the heat transfer is best on the side of the lower temperature fluid or on the side of the fluid with the best heat transfer coefficient for cooling. For operation cases, where the media cooling fails, water-cooling of the feed channels starts which is distant to the high-temperature synthesis gas atmosphere at a level of the reactor metal shell. The water-cooling surrounds all injected media and prevents the break-through of high-temperature synthesis gas. This segregated cooling far from the high-temperature synthesis gas atmosphere ensures sufficient cooling of the burner arrangement during all operational cases. In addition, the high mechanical stress of the parts in contact with the high-temperature synthesis gas atmosphere is avoided. The high-temperature synthesis gas atmosphere cannot burn backward via the oxygen or feed channels so the burner arrangement is inherently safe. Accordingly, the operational life of the burner is improved.

In an embodiment, the first reaction medium is the fluid or fluidized carbon-containing fuels. The second reaction medium is the oxygen-containing oxidant. The third reaction medium is the moderator containing steam and/or carbon dioxide. During shut-down of the reaction chamber, either high-pressure nitrogen or steam is injected into the reaction chamber via the fluid or fluidized carbon-containing fuel stream, the oxygen-containing oxidant stream, and the moderator stream feed channels for prevention of backflow and flushing of the reaction chamber inventory. Equidistribution devices may be provided downstream of the fluid or fluidized carbon-containing fuel stream, the oxygen-containing oxidant stream, and/or the moderator stream feed channels to facilitate uniform distribution of the fluid or fluidized carbon-containing fuel stream, the oxygen-containing oxidant stream, and the moderator stream into the reaction chamber.

Optionally, both the outer wall of the at least one burner corresponding to part B of the length of the feed channels and the side of the at least one burner mounting plate facing away from the interior of the reaction chamber are designed to allow cooling by indirect heat exchange with a common cooling fluid stream. The common cooling fluid stream moves parallel to the at least one burner outer wall on a first part of its path and moves perpendicular to the at least one burner outer wall on a second part of its path. Cooling of the at least one burner outer wall is effected on the first portion of the path and wherein cooling of the burner mounting plate is effected on the second portion of the path.

The burner arrangement includes a first cooling pipe through which the common cooling fluid stream flows. The first cooling pipe is co-annular towards the feed channels in the case of a single co-annular feed channel set. In the case of multiple co-annular feed channel sets, the cooling water pipe surrounds all feed channel sets. The burner arrangement further comprises a second cooling pipe, which is co-annular to the first cooling pipe. The first and second cooling water pipes are aligned with the reactor flange or above the reactor flange and are in fluid connection. The flange for fluid-tight connecting of the at least one burner to the reactor chamber is either welded to the second cooling pipe or both welded to the second or third feed channel respectively and the second cooling pipe in such a manner that the reaction chamber flange diameter is minimized in size (diameter of second or third feed channel) and that the at least one burner including the feed channels flange and reactor flange is also cooled by the flow in the cooling pipes.

Optionally, the common cooling fluid stream moves in co-current or counter-current manner on the first portion of its path, relative to the flow of a reaction medium through at least one of the feed channels.

Optionally, at least two burners are mounted on and fluid-tightly connected to a common burner mounting plate that is detachably connectable to the outer wall surface, preferably at the top of the reaction chamber. Both the outer walls of all burners corresponding to part B of the length of the feed channels and the side of the common burner mounting plate facing away from the interior of the reaction chamber are designed to allow cooling by indirect heat exchange with a common cooling fluid stream. The common cooling fluid stream moves parallel to the burner outer wall of a first burner on a first part of its path and moves perpendicular to the burner outer wall of the first burner on a second part of its path and moves parallel to the burner outer wall of a second burner on a third part of its path. Cooling of the burner outer wall of the first burner is effected on the first part of the path, cooling of the burner mounting plate is effected on the second part of the path, and cooling of the burner outer wall of the second burner is effected on the third part of its path.

Optionally, the common cooling fluid stream moves in co-current manner, relative to the flow of a reaction medium through at least one of the feed channels of the first burner, on the first part of its path and in counter-current manner, relative to the flow of a reaction medium through at least one of the feed channels of the second burner, on the third part of its path, or the common cooling fluid stream moves in counter-current manner, relative to the flow of a reaction medium through at least one of the feed channels of the first burner, on the first part of its path and in co-current manner, relative to the flow of a reaction medium through at least one of the feed channels of the second burner, on the third part of its path.

Optionally, the burner arrangement comprises a first feed channel and a second feed channel and a first mixing device that allows mixing of a carbon-containing fuel stream and a moderator stream or mixing of an oxidant stream and a moderator stream, to yield a first mixed medium stream, the first mixed medium stream being fed to one of the first feed channel or second feed channel, and the third reaction medium stream being fed to the remaining feed channel. The carbon-containing fuel stream is a mixture of feedstock and steam. The oxidant stream is a mixture of oxygen and steam.

Optionally, the burner arrangement comprises a second mixing device that allows mixing of a particulate solid carbon stream, preferably comprising coal or coke, with a moderator stream, to yield a fluidized carbon-containing fuel stream, or mixing of a liquid carbon-containing stream, preferably comprising liquid hydrocarbons, with a moderator stream, to yield an atomized carbon-containing fuel stream. The second mixing device is arranged upstream of the at least one burner and is in fluid connection with one of the feed channels of the at least one burner. The atomization of liquid hydrocarbon feedstock, for example, preheated oil residue, is performed in a dedicated atomization device upstream of the at least one burner comprising the feed channels. The coal or coke is mixed with steam, upstream of the at least one burner comprising the feed channels.

Optionally, at least one of the feed channels of at least one burner is equipped with a swirl-inducing device. The first feed channel and/or second feed channel include casted metal parts with helical guiding vanes to create a swirling flow of the fluid or fluidized carbon-containing fuel stream and/or the oxygen-containing oxidant stream. The swirling flow of the fluid or fluidized carbon-containing fuel stream and/or the oxygen-containing oxidant stream may be in counter-direction.

Optionally, the means for feeding the oxygen-containing oxidant stream is in fluid connection with the first feed channel, the means for feeding the fluid or fluidized carbon-containing fuel stream is in fluid connection with the second feed channel, and the means for feeding the moderator stream is in fluid connection with the third feed channel, or the means for feeding the oxygen-containing oxidant stream is in fluid connection with the first feed channel, the means for feeding the moderator stream is in fluid connection with the second feed channel, and the means for feeding the fluid or fluidized carbon-containing fuel stream is in fluid connection with the third feed channel. In an embodiment, the oxygen-containing oxidant stream is injected into the second feed channel, the fluid or fluidized carbon-containing fuel stream is injected into the first feed channel, and the moderator stream is optionally injected into the third feed channel. In another embodiment, the oxygen-containing oxidant stream is injected into the second feed channel, the moderator stream is injected into the first feed channel, and the fluid or fluidized carbon-containing fuel stream is injected into the third feed channel. The outlet of the third feed channel is aligned with the refractory lining of the reaction chamber. The second feed channel or the third feed channel, in the case of the optional third co-annulus, is shielded from the synthesis gas in the reaction chamber and surrounded by refractory, castable, or ceramic material.

Optionally, the gap between the outer wall of the at least one burner and the inner face of the opening is filled with a solid insulating material, preferably with ceramic paper. In this way, a gap between the outer wall of the at least one burner and the inner face of the opening is minimized, or even closed completely, and an intrusion of the high temperature corrosive atmosphere inside the reaction chamber is minimized, or even avoided completely.

Optionally, the cooling fluid stream is supplied using a flexible conduit, preferably a flexible hose, so that the cooling fluid stream can be supplied when the at least one burner is detached from the reaction chamber. This is advantageous since the at least one burner can still be cooled by the cooling fluid stream, thus decreasing the cooling time before re-attachment of the at least one burner to the reaction chamber, and also reducing burning hazards to operational personnel.

Optionally, means are comprised that allow feeding of liquid water as cooling medium at a pressure that is higher than the gas pressure in the reaction chamber.

Optionally, all of its parts being exposed to the synthesis gas at temperatures between 400 and 800° C. are covered with a layer of a corrosion protection material, the corrosion protection material being selected from the group comprising: ceramic material; alumina; aluminium, preferably as aluminium diffusion layer. In this way, the extent of corrosion of metal surface by synthesis gas ingredients like carbon monoxide or hydrogen, called Metal Dusting Corrosion (MDC), is greatly reduced or even avoided completely.

Optionally, the burner mounting plate or common burner mounting plate comprises an additional opening, the inner face of the additional opening being cooled by the cooling medium, the additional opening allowing insertion of a start-up burner during start-up of the burner arrangement and being closed with a plug made of a refractory material during normal operation of the burner arrangement. One of the multiple co-annular feed channels is replaced by a cooled access opening for the start-up burner, which is blocked by a cylindrical refractory brick during normal operation.

Optionally, the length A is chosen so that the burner mouth and the inner surface of the refractory lining lie in a common plane. This minimizes or even avoids completely that any parts of the at least one burner protrude into the interior of the reaction chamber. Thus, the extent of corrosion of metal surface by synthesis gas ingredients like carbon monoxide or hydrogen, called Metal Dusting Corrosion (MDC), is further reduced or even avoided completely.

According to a second aspect, the present disclosure provides a use of a burner arrangement for producing a hydrogen and carbon oxides containing synthesis gas by oxidation of fluid or fluidized carbon-containing fuels in the presence of an oxygen-containing oxidant and a moderator containing steam and/or carbon dioxide by catalytic partial oxidation (CPDX), non-catalytic partial oxidation (PDX) or autothermal reforming (ATR).

Embodiments of the present disclosure substantially eliminate or at least partially address the aforementioned technical drawbacks in existing technologies by providing a burner arrangement comprising of one or more media cooled co-annular feed channels for carbon-containing fuels, oxidant and moderator which are embedded in a refractory lining of the PDX reactor characterized by water cooling that is distant to the high-temperature synthesis gas atmosphere inside the PDX reactor.

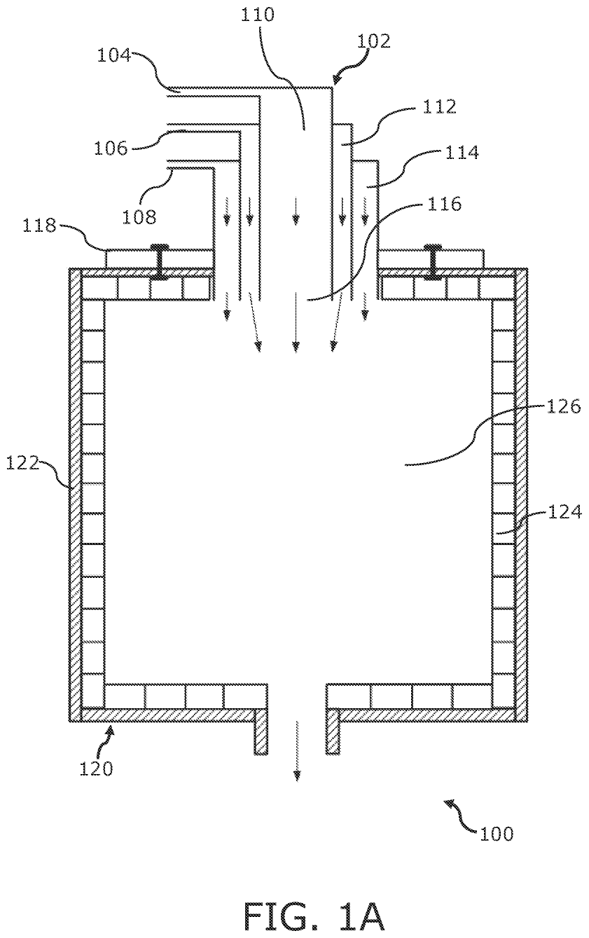

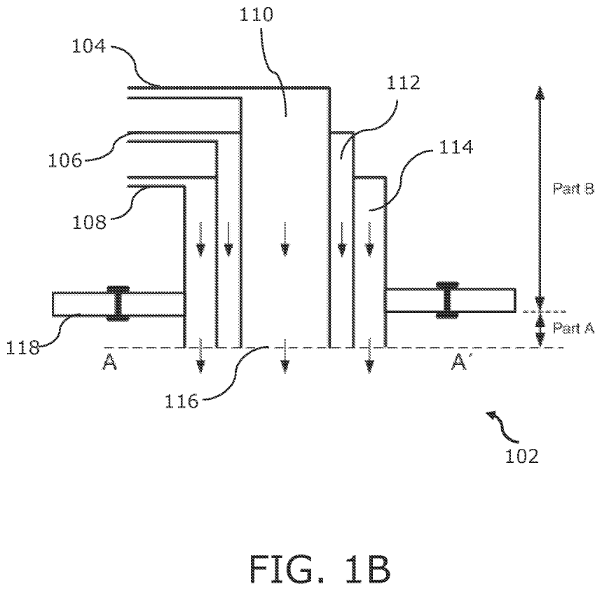

FIG. 1A is a schematic illustration of a burner arrangement 100 for producing a hydrogen and carbon oxides containing synthesis gas by non-catalytic partial oxidation of fluid or fluidized carbon-containing fuels in the presence of an oxygen-containing oxidant and a moderator containing steam and/or carbon dioxide according to an embodiment of the present disclosure. The burner arrangement 100 includes at least one burner 102, a first feed pipe 104, a second feed pipe 106, a third feed pipe 108, a reaction chamber 120. The at least one burner 102 includes a first feed channel 110 having a circular cross section. The first feed channel 110 allows feeding of a first reaction medium stream. The at least one burner 102 includes a second feed channel 112 which coaxially and concentrically surrounds the first feed channel 110 and forms an annular gap between the outer wall of the first feed channel 110 and the inner wall of the second feed channel 112. The annular gap between the outer wall of the first feed channel 110 and the inner wall of the second feed channel 112 allows feeding of a second reaction medium stream. The at least one burner 102 optionally includes a third feed channel 114 which coaxially and concentrically surrounds the second feed channel 112 forming an annular gap between the outer wall of the second feed channel 112 and the inner wall of the third feed channel 114. The annular gap between the outer wall of the second feed channel 112 and the inner wall of the third feed channel 114 allows feeding of a third reaction medium stream. The outer wall of the second feed channel 112 or optionally the outer wall of the third feed channel 114 forms the outer wall of the at least one burner 102. The outer walls of the first feed channel 110, the second feed channel 112, and the third feed channel 114 end in a first common plane (A-A′) (see FIG. 1B for detail) which runs perpendicularly to the longitudinal axis of the at least one burner 102 and forms a burner mouth 116. The outer wall of the at least one burner 102 is mounted on and is fluid-tightly connected to a burner mounting plate 118 in such a way that a part A of the length of the first feed channel 110, the second feed channel 112, and the third feed channel 114 is passed through the burner mounting plate 118 and a part B of the length of the first feed channel 110, the second feed channel 112, and the third feed channel 114 is not passed through the burner mounting plate 118 (see FIG. 1B for detail). The reaction chamber 120 includes a pressure-bearing wall 122 with an outer wall surface and an inner wall surface. A refractory lining 124 is attached to the inner wall surface of the pressure-bearing wall 122. The reaction chamber 120 includes an interior 126, being defined as the free space inside the reaction chamber 120 delimited by an inner surface of the refractory lining 124. The reaction chamber 120 includes an opening for insertion of the at least one burner 102 mounted on the burner mounting plate 118 into the reaction chamber 120. The at least one burner 102 is mounted on the burner mounting plate 118 and inserted into the reaction chamber 120 via the opening in such a way that the part A of the length of the first feed channel 110, the second feed channel 112, and the third feed channel 114 is located at least partially inside of the interior 126 and/or inside of the refractory lining 124, and the part B of the length of the first feed channel 110, the second feed channel 112, and the third feed channel 114 is located outside of the interior 126 of the reaction chamber 120. The burner mounting plate 118 is detachably connectable in a fluid-tight manner, preferably using a flange connection to the outer wall surface of the reaction chamber 120. The burner mounting plate 118 may include screws with bolts and nuts for the flange connection. Both the portion of the outer wall of the at least one burner 102 corresponding to part B of the length of the first feed channel 110, the second feed channel 112, and the third feed channel 114 and the side of the at least one burner mounting plate 118 facing away from the interior 126 of the reaction chamber 120 are designed to allow cooling by indirect heat exchange with a cooling fluid.

FIG. 1B is a schematic illustration of the at least burner 102 of FIG. 1A according to an embodiment of the present disclosure. The at least one burner 102 includes the first feed channel 110 having circular cross-section. The first feed channel 110 allows feeding of the first reaction medium stream. The at least one burner 102 includes the second feed channel 112 which coaxially and concentrically surrounds the first feed channel 110 and forms the annular gap between the outer wall of the first feed channel 110 and the inner wall of the second feed channel 112. The annular gap between the outer wall of the first feed channel 110 and the inner wall of the second feed channel 112 allows feeding of the second reaction medium stream. The at least one burner 102 optionally includes the third feed channel 114 which coaxially and concentrically surrounds the second feed channel 112 forming an annular gap between the outer wall of the second feed channel 112 and the inner wall of the third feed channel 114. The annular gap between the outer wall of the second feed channel 112 and the inner wall of the third feed channel 114 allows feeding of the third reaction medium stream. The outer wall of the second feed channel 112 or optionally the outer wall of the third feed channel 114 forms the outer wall of the at least one burner 102. The outer walls of the first feed channel 110, the second feed channel 112, and the third feed channel 114 ends in a first common plane (A-A′) which runs perpendicularly to the longitudinal axis of the at least one burner 102 and forms the burner mouth 116. The outer wall of the at least one burner 102 is mounted on and is fluid-tightly connected to the burner mounting plate 118 in such a way that a part A of the length of the first feed channel 110, the second feed channel 112, and the third feed channel 114 is passed through the burner mounting plate 118 and a part B of the length of the first feed channel 110, the second feed channel 112, and the third feed channel 114 is not passed through the burner mounting plate 118.

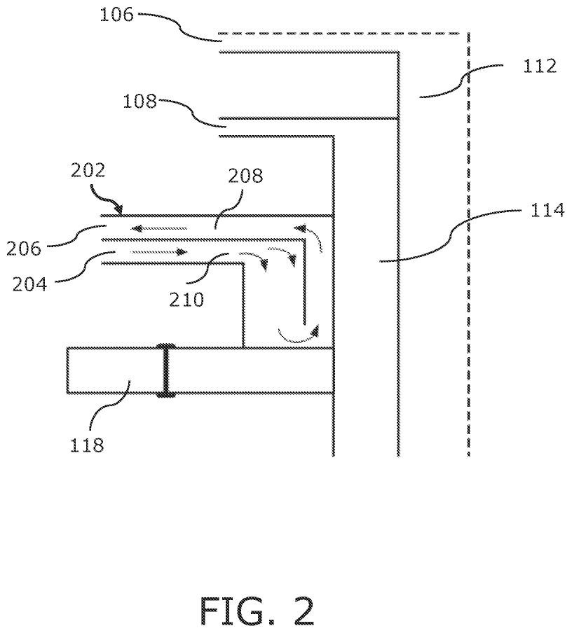

FIG. 2 is a schematic illustration of details of a cooling fluid channel 202 of the burner arrangement 100 of FIG. 1A according to an embodiment of the present disclosure. The cooling fluid channel 202 includes a cooling fluid inlet 204 and a cooling fluid outlet 206. A common cooling fluid stream flows through the cooling fluid inlet 204 and is returned through the cooling fluid outlet 206. The common cooling fluid stream flows from the cooling fluid inlet 204 in the injection direction through a second cooling pipe 210 into a first cooling pipe 208 wherein the second cooling pipe 210 is in fluid connection with the first cooling pipe 208, and then flows against the injection direction through the first cooling pipe 208 to the cooling fluid outlet 206. The outer wall of the at least one burner 102 corresponding to part B of the length of the first feed channel 110, the second feed channel 112, and the third feed channel 114 and the side of the at least one burner mounting plate 118 facing away from the interior 126 of the reaction chamber 120 are designed to allow cooling by indirect heat exchange with the common cooling fluid stream. The common cooling fluid stream moves parallel to the at least one burner 102 outer wall on a first part of its path and moves perpendicular to the at least one burner 102 outer wall on a second part of its path. All flows moving perpendicular to the at least one burner 102 outer wall shall be understood as being elements of the second part of the flow path, irrespective whether they flow into or out of cooling fluid channel 202. The cooling of the at least one burner 102 outer wall is effected on the first portion of the path and cooling of the burner mounting plate 118 is effected on the second part of the path. The common cooling fluid stream may move in co-current or counter-current manner on the first portion of its path, relative to the flow of a reaction medium through the first feed channel 110, the second feed channel 112, and the third feed channel 114. The embodiment shown in FIG. 2 corresponds to a counter-current movement of the common cooling fluid stream relative to the flow of a reaction medium through the feed channels.

Modifications to embodiments of the present disclosure described in the foregoing are possible without departing from the scope of the present disclosure as defined by the accompanying claims. Expressions such as “including”, “comprising”, “incorporating”, “have”, “is” used to describe, and claim the present disclosure are intended to be construed in a non-exclusive manner, namely allowing for items, components or elements not explicitly described also to be present. Reference to the singular is also to be construed to relate to the plural.

### LIST OF REFERENCE NUMERALS

100—burner arrangement
102—at least one burner
104—first feed pipe
106—second feed pipe
108—third feed pipe
110—first feed channel
112—second feed channel
114—third feed channel
116—burner mouth
118—burner mounting plate
120—reaction chamber
122—pressure bearing wall
124—refractory lining
126—interior of the reaction chamber
202—cooling fluid channel
204—cooling fluid inlet
206—cooling fluid outlet
208—first cooling pipe
210—second cooling pipe

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A burner arrangement for producing a hydrogen and carbon oxides containing synthesis gas by non-catalytic or catalytic partial oxidation of fluid or fluidized carbon-containing fuels in the presence of an oxygen-containing oxidant and a moderator containing steam and/or carbon dioxide, comprising following parts or assemblies:
(a) a feeding means for separately feeding three fluid reaction media streams or two fluid and one fluidized reaction media streams into a burner, wherein the three reaction media streams are selected from the group comprising: a fluid or fluidized carbon-containing fuel stream, an oxygen-containing oxidant stream and a moderator stream,
(b) at least one burner, comprising:
(b1) a first feed channel having a circular cross section, configured to allow feeding of the first reaction medium stream,
(b2) a second feed channel which coaxially and concentrically surrounds the first feed channel, forming an annular gap between the outer wall of the first feed channel and the inner wall of the second feed channel, configured to allow feeding of the second reaction medium stream,
(b3) a third feed channel which coaxially and concentrically surrounds the second feed channel, forming an annular gap between the outer wall of the second feed channel and the inner wall of the third feed channel, configured to allow feeding of the third reaction medium stream,
(b4) wherein the outer wall of the second feed channel or the outer wall of the third feed channel forms the outer wall of the at least one burner,
(b5) wherein the outer walls of all feed channels end in a first common plane that runs perpendicularly to the longitudinal axis of the burner and forms a burner mouth,
(c) wherein the outer wall of the at least one burner is mounted on and is fluid-tightly connected to a burner mounting plate in such a way that a part A of the length of the feed channels is passed through the burner mounting plate and a part B of the length of the feed channels is not passed through the burner mounting plate,
(d) a reaction chamber, wherein the reaction chamber comprises:
a pressure bearing wall with an outer wall surface and an inner wall surface,
a refractory lining attached to the inner wall surface of the pressure bearing wall,
an interior, being defined as the free space inside the reaction chamber, delimited by an inner surface of the refractory lining, and
an opening for insertion of the at least one burner mounted on the burner mounting plate into the reaction chamber,
(e) wherein the at least one burner mounted on the burner mounting plate is insertable into the reaction chamber via the opening in such a way that the part A of the length of the feed channels is located at least partially inside of the interior and/or inside of the refractory lining, and the part B of the length of the feed channels is located outside of the interior of the reaction chamber, and the burner mounting plate is detachably connectable in a fluid-tight manner to the outer wall surface,
(f) wherein both the portion of the outer wall of the at least one burner corresponding to part B of the length of the feed channels and the side of the at least one burner mounting plate facing away from the interior of the reaction chamber are designed to allow cooling by indirect heat exchange with a cooling fluid.

2. The burner arrangement according to claim 1, wherein both the outer wall of the at least one burner corresponding to part B of the length of the feed channels and the side of the at least one burner mounting plate facing away from the interior of the reaction chamber) are designed to allow cooling by indirect heat exchange with a common cooling fluid stream,
wherein the common cooling fluid stream moves parallel to the at least one burner outer wall on a first part of its path and moves perpendicular to the at least one burner outer wall on a second part of its path,
wherein cooling of the at least one burner outer wall is affected on the first portion of the path and wherein cooling of the burner mounting plate is effected on the second portion of the path.

3. The burner arrangement according to claim 2, wherein the common cooling fluid stream moves in co-current or counter-current manner on the first portion of the path, relative to the flow of a reaction medium through at least one of the feed channels.

4. The burner arrangement according to claim 1, wherein at least two burners are mounted on and fluid-tightly connected to a common burner mounting plate which is detachably connectable to the outer wall surface, wherein both the outer walls of all burners corresponding to part B of the length of the feed channels and the side of the common burner mounting plate facing away from the interior of the reaction chamber are designed to allow cooling by indirect heat exchange with a common cooling fluid stream,
wherein the common cooling fluid stream moves parallel to the burner outer wall of a first burner on a first part of the path and moves perpendicular to the burner outer wall of the first burner on a second part of its path and moves parallel to the burner outer wall of a second burner on a third part of the path,
wherein cooling of the burner outer wall of the first burner is affected on the first part of the path, cooling of the burner mounting plate is affected on the second part of the path, and cooling of the burner outer wall of the second burner is affected on the third part of its path.

5. The burner arrangement according to claim 4, wherein
the common cooling fluid stream moves in co-current manner, relative to the flow of a reaction medium through at least one of the feed channels of the first burner, on the first part of the path and in counter-current manner, relative to the flow of a reaction medium through at least one of the feed channels of the second burner, on the third part of the path, or
the common cooling fluid stream moves in counter-current manner, relative to the flow of a reaction medium through at least one of the feed channels of the first burner, on the first part of the path and in co-current manner, relative to the flow of a reaction medium through at least one of the feed channels of the second burner, on the third part of the path.

6. The burner arrangement according to claim 1, further comprising the first feed channel and the second feed channel and a first mixing device that allows mixing of a carbon-containing fuel stream and a moderator stream or mixing of an oxidant stream and a moderator stream, to yield a first mixed medium stream, the first mixed medium stream being fed to one of the first feed channel or second feed channel, and the third reaction medium stream being fed to the remaining feed channel.

7. The burner arrangement according to claim 1, further comprising a second mixing device configured for
mixing of a particulate solid carbon stream with a moderator stream, to yield a fluidized carbon-containing fuel stream, or
mixing of a liquid carbon-containing stream with a moderator stream, to yield an atomized carbon-containing fuel stream,
wherein the second mixing device is arranged upstream of the at least one burner and is in fluid connection with one of the feed channels of the at least one burner.

8. The burner arrangement according to claim 1, wherein at least one of the feed channels of at least one burner is equipped with a swirl-inducing device.

9. The burner arrangement according to claim 1, wherein the feeding means for feeding the oxygen-containing oxidant stream is in fluid connection with the first feed channel, the feeding means for feeding the fluid or fluidized carbon-containing fuel stream is in fluid connection with the second feed channel, and the feeding means for feeding the moderator stream is in fluid connection with the third feed channel, or
the feeding means for feeding the oxygen-containing oxidant stream is in fluid connection with the first feed channel, the feeding means for feeding the moderator stream is in fluid connection with the second feed channel, and the feeding means for feeding the fluid or fluidized carbon-containing fuel stream is in fluid connection with the third feed channel.

10. The burner arrangement according to claim 1, wherein the gap between the outer wall of the at least one burner and the inner face of the opening is filled with a solid insulating material.

11. The burner arrangement according to claim 1, wherein the cooling fluid stream is supplied using a flexible conduit so that the cooling fluid stream can be supplied when the at least one burner is detached from the reaction chamber.

12. The burner arrangement according to claim 1, wherein the feeding means are comprised that allow feeding of liquid water as cooling medium at a pressure which is higher that the gas pressure in the reaction chamber.

13. The burner arrangement according to claim 1, wherein all the parts being exposed to the synthesis gas at temperatures between 400 and 800° C. are covered with a layer of a corrosion protection material, the corrosion protection material being selected from the group comprising: ceramic material; alumina; aluminium, preferably as aluminium diffusion layer.

14. The burner arrangement according to claim 1, wherein the burner mounting plate or common burner mounting plate comprises an additional opening, the inner face of the additional opening being cooled by the cooling medium, the additional opening allowing insertion of a start-up burner during start-up of the burner arrangement and being closed with a plug made of a refractory material during normal operation of the burner arrangement.

15. The burner arrangement according to claim 1, wherein the length A is chosen so that the burner mouth and the inner surface of the refractory lining lie in a common plane.
